(19) United States
(12) Patent Application Publication
(10) Pub. No.: US 2026/0278055 A1
(43) Pub. Date: Sep. 17, 2026

(54) DISPLAY APPARATUS, AUTHENTICATION SYSTEM, AND AUTHENTICATION METHOD

(71) Applicant: NEC Corporation, Tokyo (JP)

(72) Inventors: Kazuyuki SASAKI, Tokyo (JP); Junichi KAMIMURA, Tokyo (JP); Yusuke MORISHITA, Tokyo (JP)

(73) Assignee: NEC Corporation, Tokyo (JP)

(21) Appl. No.: 19/473,264

(22) PCT Filed: Apr. 14, 2023
(86) PCT No.: PCT/JP2023/015194

§ 371 Date: Oct. 7, 2025

(51) Int. Cl. G06F 21/32; G06V 40/16

(52) U.S. Cl. CPC G06F 21/32; G06V 40/16

(57) ABSTRACT

A display apparatus includes: a display unit including a plurality of display areas located at different heights; a first control unit that controls the display unit to perform guidance display for guiding a facial orientation of a target toward an imaging unit; an authentication result acquisition unit that acquires authentication result information indicating a result of authentication processing for the target; and a second control unit that controls the display unit to perform result display corresponding to the authentication result information. According to such a display apparatus, it is possible to appropriately perform the authentication processing by guiding the facial orientation of the target and appropriately notify the target of the authentication result.

### TECHNICAL FIELD

The present disclosure relates to technical fields of a display apparatus, an authentication system, an authentication method, and a recording medium.

### BACKGROUND ART

There is known a technique/technology of performing authentication processing on a target and displaying a result of the authentication processing on a display apparatus. For example, Patent Literature 1 discloses a technique/technology of performing authentication processing by using biometric information on a pedestrian and of displaying an authentication result near the pedestrian's feet.

As another related technique/technology, Patent Literature 2 discloses a technique/technology of determining the position of a display area based on a target's height. Patent Literature 3 discloses a technique/technology of calculating the position of a target's eyes and the position of the top of a target's head from an image and of adjusting a display area for display data. Patent Literature 4 discloses a technique/technology of capturing images of a display apparatus by using a plurality of cameras and of detecting the position of the display apparatus.

### CITATION LIST

### Patent Literature

[Patent Literature 1] International Publication No. WO2022/003851

[Patent Literature 2] JP2021-009186A

[Patent Literature 3] JP2010-061063A

[Patent Literature 4] JP2005-099064A

### SUMMARY

### Technical Problem

The present disclosure aims to improve the techniques/technologies disclosed in Citation List.

### Solution to Problem

A display apparatus according to an example aspect of the present disclosure includes: a display unit including a plurality of display areas located at different heights; a first control unit that controls the display unit to perform guidance display for guiding a facial orientation of a target toward an imaging unit; an authentication result acquisition unit that acquires authentication result information indicating a result of authentication processing for the target; and a second control unit that controls the display unit to perform result display corresponding to the authentication result information.

An authentication system according to an example aspect of the present disclosure includes: an image acquisition unit that acquires an image of a target; an authentication unit that performs authentication processing by using the image of the target; a position acquisition unit that acquires a position of the target; an output unit that outputs authentication result information indicating a result of the authentication processing for the target, based on the position of the target; and a display apparatus that is disposed in an area through which the target passes and that performs result display corresponding to the authentication result information to the target.

An authentication method according to an example aspect of the present disclosure is an authentication method that is executed by at least one computer, the authentication method including: acquiring an image of a target; performing authentication processing by using the image of the target; acquiring a position of the target; outputting authentication result information indicating a result of the authentication processing for the target, based on the position of the target; and using a display apparatus that is disposed in an area through which the target passes, thereby performing result display corresponding to the authentication result information to the target.

A recording medium according to an example aspect of the present disclosure is a recording medium on which a computer program that allows at least one computer to execute an authentication method is recorded, the authentication method including: acquiring an image of a target; performing authentication processing by using the image of the target; acquiring a position of the target; outputting authentication result information indicating a result of the authentication processing for the target, based on the position of the target; and using a display apparatus that is disposed in an area through which the target passes, thereby performing result display corresponding to the authentication result information to the target.

### BRIEF DESCRIPTION OF DRAWINGS

FIG. 1 is a perspective view illustrating a configuration of a display apparatus according to a first example embodiment.

FIG. 2 is a plan view illustrating a configuration of a display unit in the display apparatus according to the first example embodiment.

FIG. 3 is a block diagram illustrating a functional configuration of the display apparatus according to the first example embodiment.

FIG. 4 is a flowchart illustrating a flow of operation of the display apparatus according to the first example embodiment.

FIG. 5 is version 1 of a conceptual diagram illustrating an operation example of guidance display by a display apparatus according to a second example embodiment.

FIG. 6 is version 2 of a conceptual diagram illustrating an operation example of the guidance display by the display apparatus according to the second example embodiment.

FIG. 7 is a conceptual diagram illustrating an operation example of result display by the apparatus according to the second example embodiment.

FIG. 8 is a block diagram illustrating a hardware configuration of an authentication system according to a third example embodiment.

FIG. 9 is a side view illustrating a configuration of the authentication system according to the third example embodiment.

FIG. 10 is a flowchart illustrating a flow of operation of the authentication system according to the third example embodiment.

FIG. 11 is a block diagram illustrating a configuration of a processing apparatus in an authentication system according to a fourth example embodiment.

FIG. 12 is a flowchart illustrating a flow of a calibration operation in the authentication system according to the fourth example embodiment.

FIG. 13 is a flowchart illustrating a flow of operation of the authentication system according to the fourth example embodiment.

FIG. 14 is a top view illustrating a control example of a plurality of display apparatuses in the authentication system according to the fourth example embodiment.

### DESCRIPTION OF EXAMPLE EMBODIMENTS

Hereinafter, a display apparatus, an authentication system, an authentication method, and a recording medium according to example embodiments will be described with reference to the drawings.

### First Example Embodiment

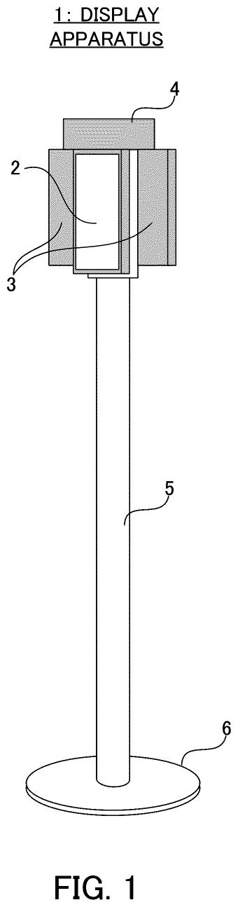

A display apparatus according to a first example embodiment will be described with reference to FIG. 1 to FIG. 4.

### Configuration of Apparatus

First, with reference to FIG. 1, a configuration of the display apparatus according to the first example embodiment will be described. FIG. 1 is a perspective view illustrating the configuration of the display apparatus according to the first example embodiment.

As illustrated in FIG. 1, a display apparatus 1 according to the first example embodiment includes a display unit 2, a battery 3, a control unit 4, a pole 5, and a flat plate 6. Although not visible in FIG. 1 due to a blind spot, another display unit 2 is provided on a rear side of the display unit 2. The number of the display units 2, however, is not specifically limited; only one display unit 2 may be provided, or three or more display units 2 may be provided.

The display unit 2 includes, for example, a plurality of LEDs (Light Emitting Diodes). Alternatively, the display unit 2 may include a liquid crystal display. The display unit 2 is configured to perform various display operations under the control of the control unit 4. The display operations of the display unit 2 will be described in detail later.

The battery 3 includes a rechargeable battery, such as, for example, a lithium-ion battery. An electrical power stored in the battery 3 is used for the operation of the display unit 2 and the control unit 4.

The control unit 4 is a controller that performs various types of processing in the display apparatus 1. The control unit 4 is configured to control at least the display operations in the display unit 2. Furthermore, the control unit 4 may be configured to transmit and receive various types of information to and from an external apparatus via wireless communication or similar means. A specific configuration of the control unit 4 will be described in detail later.

The display unit 2, the battery 3, and the control unit 4 described above are held by the pole 5 and the flat plate 6. The pole 5 may be configured to be extendable and contractible. In this case, extending or contracting the pole allows the height of the display unit 2 to be changed. Furthermore, the flat plate 6 may not be fixed to an installation surface. In this case, the display apparatus 1 is portable, thereby allowing its installation position to be adjusted as appropriate depending on operating status.

### Configuration of Display Unit

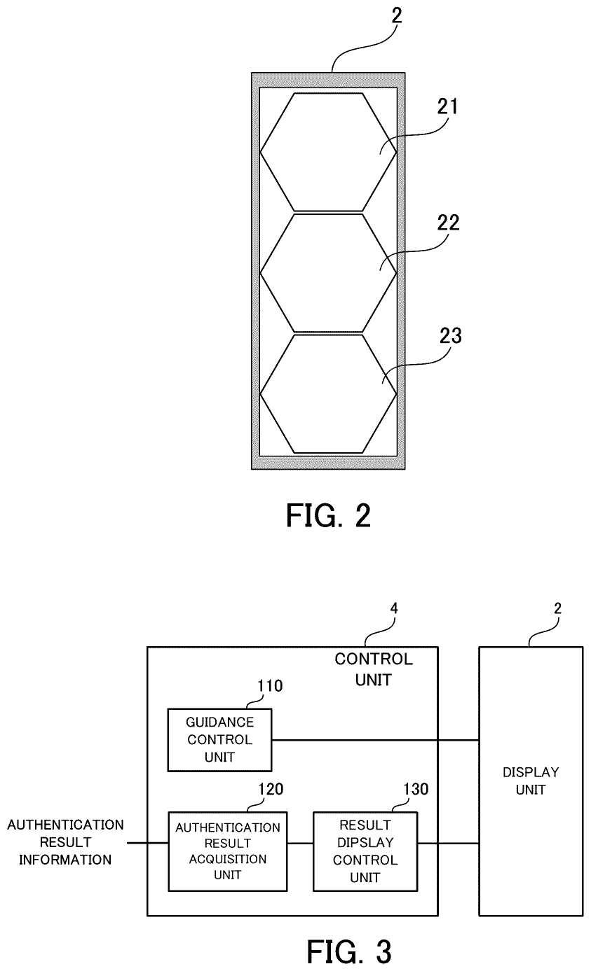

Next, with reference to FIG. 2, a configuration of the display unit 2 in the display apparatus 1 according to the first example embodiment will be specifically described. FIG. 2 is a plan view illustrating the configuration of the display unit in the display apparatus according to the first example embodiment.

As illustrated in FIG. 2, the display unit 2 of the display apparatus 1 according to the first example embodiment includes a plurality of display areas 21, 22, and 23. Although the present example embodiment shows an example in which the display unit 2 has three display areas, the number of the display areas is not particularly limited. The display areas 21, 22, and 23 are provided at different heights. In other words, the display unit 2 is configured to independently light them up (display) at different heights. The display unit 2 may alternatively be configured to have a single display area that is allowed to be lit up separately at different heights, instead of the plurality of display areas.

The display unit 2 may be installed at a height determined based on the height of a target supposed to see the displayed content (in other words, the height of a line of sight). For example, the display unit 2 may be installed such that the display area at the lowest position is 140 cm and the display area at the highest position is 170 cm.

Next, with reference to FIG. 3, a functional configuration of the display apparatus 1 according to the first example embodiment will be described. FIG. 3 is a block diagram illustrating the functional configuration of the display apparatus according to the first example embodiment. Note that FIG. 3 illustrates only the display unit 2 and the control unit 4 of the display apparatus 1, omitting other elements.

As illustrated in FIG. 3, the control unit 4 of the display apparatus 1 according to the first example embodiment includes, as components for realizing its functions, a guidance control unit 110, an authentication result acquisition unit 120, and a result display control unit 130.

The guidance control unit 110 outputs an instruction to the display unit 2 to perform guidance display. The guidance display is intended to guide a face orientation of the target in a direction in which an imaging unit (a camera) is disposed. Here, the imaging unit may be intended, for example, to capture images used for authentication processing for the target. For instance, in a case where the imaging unit is disposed at a position higher than a face of the target, the guidance display may be display that prompts the target, who is looking down, to look up. A specific example of the guidance display will be described in detail in another example embodiment later.

The authentication result acquisition unit 120 is configured to acquire authentication result information indicating a result of the authentication processing for the target. The authentication result acquisition unit 120 acquires the authentication result information, for example, from an external authentication apparatus by using wireless communication. The type of the authentication processing here is not particularly limited, but an example is biometric authentication using biometric information. More specifically, the authentication processing may be facial recognition using the face of the target, iris recognition using an iris, or the like. Furthermore, the authentication processing may not be performed only once at a specific location, but may be performed a plurality of times. For example, the authentication processing may be performed a plurality of times while the target is tracked in a specific facility.

The result display control unit 130 outputs an instruction to the display unit 2 to perform result display. The result display is intended to indicate the result of the authentication processing for the target and is performed based on the authentication result information acquired by the authentication result acquisition unit 120. Typically, the result is displayed to the target, but may also be displayed to parties other than the target. For example, the result may be displayed to a system administrator or the like managing the system that performs the authentication processing. A specific example of the result display will be described in detail in another example embodiment later.

### Flow of Operation

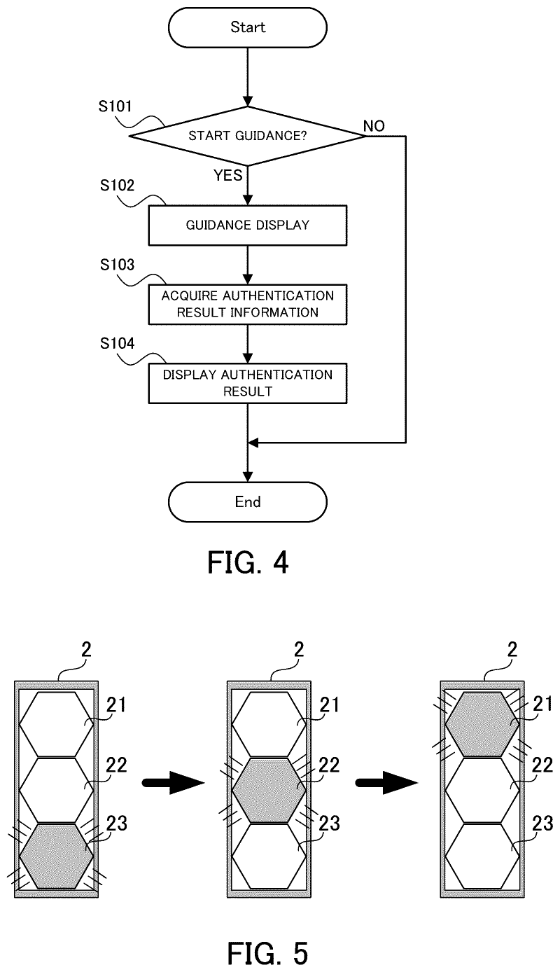

Next, with reference to FIG. 4, a flow of operation of the display apparatus 1 according to the first example embodiment will be described. FIG. 4 is a flowchart illustrating the flow of the operation of the display apparatus according to the first example embodiment.

As illustrated in FIG. 4, when the operation by the display apparatus 1 according to the first example embodiment is started, first, the guidance control unit 110 determines whether or not to start the guidance display for the target (step S101). The guidance control unit 110 may determine to start the guidance display, for example, in a case where the target approaches the display apparatus 1. The approach of the target may be detected, for example, by using an image of the target captured by a camera, or by using other sensors, or the like. In a case where the guidance control unit 110 determines not to start the guidance display (step S101: NO), subsequent processing may be omitted.

In a case where it is determined that the guidance display is to be started (step S101: YES), the guidance control unit 110 controls the display unit 2 to perform the guidance display (step S102). This causes the facial orientation of the target to be guided toward the imaging unit. This result in a situation where a facial image of the target is easily captured, thereby enabling proper execution of the biometric authentication such as facial recognition.

Subsequently, the authentication result acquisition unit 120 acquires the authentication result information indicating the result of the authentication processing (step S103). Then, the result display unit 130 controls the display unit 2 to perform the result display corresponding to the authentication result information (step S104).

### Technical Effect

Next, a technical effect obtained by the display apparatus 1 according to the first example embodiment will be described.

As described in FIG. 1 to FIG. 4, the display apparatus 1 according to the first example embodiment performs the guidance display for guiding the facial orientation of the target and performs the result display indicating the result of the authentication processing for the target. In this way, guiding the facial orientation of the target enables proper execution of the authentication processing, and the target may be appropriately notified of the authentication result.

### Second Example Embodiment

The display apparatus 1 according to a second example embodiment will be described with reference to FIG. 5 to FIG. 7. The second example embodiment indicates a specific display example using the display apparatus 1 according to the first example embodiment described above, and may be the same as the first example embodiment in its apparatus configuration and flow of operation. For this reason, a part differing from the first example embodiment already described will be described in detail below, and a description of the other overlapping parts will be omitted as appropriate.

### Guidance Display

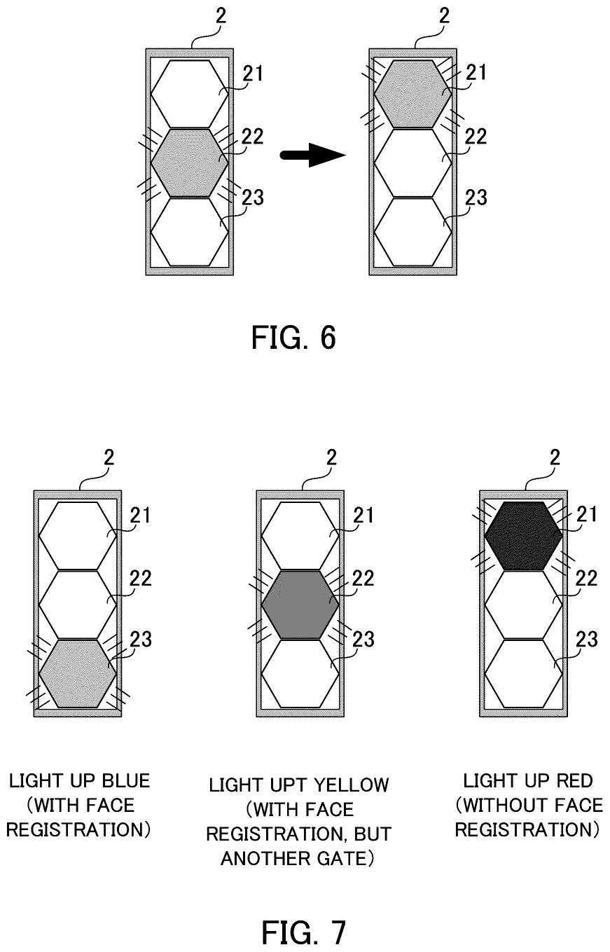

First, with reference to FIG. 5 and FIG. 6, the guidance display (i.e., the display for guiding the facial orientation of the target) by the display apparatus 1 according to the second example embodiment will be specifically described. FIG. 2 is a plan view illustrating a configuration of the display unit in the display apparatus according to the first example embodiment. FIG. 5 is version 1 of a conceptual diagram illustrating an operation example of the guidance display by the display apparatus according to the second example embodiment. FIG. 6 is version 2 of a conceptual diagram illustrating an operation example of the guidance display by the display apparatus according to the second example embodiment.

As illustrated in FIG. 5, when the guidance display is performed, such control is performed that the display areas 21, 22, and 23 in the display unit 2 are lit up first from a lower part and then gradually to a higher part. Specifically, the display unit 2 is controlled to first light up the display area 23 located at the lowest position, followed by the display area 22 located in the middle, and finally the display area 21 located at the highest position. According to such guidance display, it is possible to guide the target, who is looking down, to look up.

Furthermore, the guidance control unit 110 may perform the guidance display corresponding to the target's height. For example, in a case where the target is short in height, the lighting may start from a relatively low position, and in a case where the target is tall, the lighting may start from a relatively high position. Specifically, in a case where the target is short, as illustrated in FIG. 5, the display unit 2 may be controlled to first light up the display area 23 located at the lowest position. Conversely, in a case where the target is tall, as illustrated in FIG. 6, the display unit 2 may be controlled to first light up the middle display area 22, followed by the display area 21 located at the highest position. In this way, it is possible to appropriately perform the guidance display even on targets with different heights (in other words, targets with different eye-levels).

The target's height may be estimated from the image of the target. For example, the target's height may be estimated from the position of feet and the position of the face of the target in the image. However, a method of acquiring the target's height is not limited to the above method.

### Result Display

Next, with reference to FIG. 7, the result display (i.e., the display indicating the result of the authentication processing for the target) by the display apparatus 1 according to the second example embodiment will be specifically described. FIG. 2 is a plan view illustrating the configuration of the display unit in the display apparatus according to the first example embodiment. FIG. 7 is a conceptual diagram illustrating an operation example of the result display by the apparatus according to the second example embodiment.

FIG. 7 illustrates an example of the authentication processing performed at airport boarding gates or the like, for example. In the facial recognition at boarding gates, targets whose facial images are registered in advance, are guided to facial recognition gates (i.e., gates that can be passed through using the facial recognition) to improve throughput. However, in a case where targets whose facial images are not registered in advance, line up at the facial recognition gate, the throughput decreases. Therefore, pre-authentication may be performed to determine whether or not a target has registered his/her facial image in advance and to perform screening accordingly. The result display according to the present example embodiment displays this screening result (i.e., a result of the authentication processing regarding whether or not the facial image is registered).

As illustrated in FIG. 7, for a target whose facial image is registered, the display area 23 in the display unit 2 lights up blue. For a target whose facial image is registered, but who requires a different gate (i.e., needs to line up at another gate), the display area 22 in the display unit 2 lights up yellow. For a target whose facial image is not registered, the display area 21 in the display unit 2 lights up red. Provided here is an example in which a different display area lights up for each color, but the same display area may light up for different colors. For example, the display area 21 may light up blue, yellow, or red. Additionally, a plurality of areas may light up simultaneously. For example, for a target whose facial image is registered, all the display areas 21, 22, and 23 in the display unit 2 may light up blue.

In the example illustrated in FIG. 7, the lighting color changes depending on the authentication result, but changes other than the color are also possible. For example, the display unit 2 may change its brightness depending on the authentication result, or may perform predetermined highlighting display (e.g., flashing display). By changing a light emission pattern depending on the authentication result in this manner, the target may be notified of the authentication result in an easy-to-understand manner.

### Third Example Embodiment

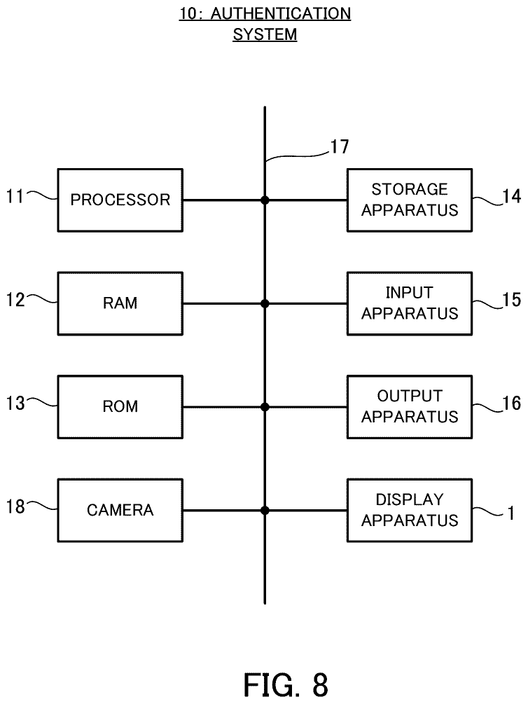

The authentication system according to q third example embodiment will be described with reference to FIG. 8 to FIG. 10.

### Hardware Configuration

First, with reference to FIG. 8, a hardware configuration of the authentication system according to the third example embodiment will be described. FIG. 8 is a block diagram illustrating the hardware configuration of the authentication system according to the third example embodiment.

As illustrated in FIG. 8, an authentication system 10 according to the third example embodiment includes a processor 11, a RAM (Random Access Memory) 12, and a ROM (Read-Only Memory) 13. The authentication system 10 may further include a storage apparatus 14, an input apparatus 15, and an output apparatus 16. The authentication system 10 also includes a camera 18 and the display apparatus 1. The processor 11, the RAM 12, the ROM 13, the storage apparatus 14, the input apparatus 15, the output apparatus 16, the camera 18, and the display apparatus 1 described above are connected via a data bus 17. configured to read a computer program stored in at least one of the RAM 12, the ROM 13, and the storage apparatus 14. Alternatively, the processor 11 may read a computer program stored on a computer-readable recording medium, by using a not-illustrated recording medium reading apparatus. The processor 11 may also acquire (i.e., read) a computer program from a not-illustrated apparatus disposed outside the authentication system 10 via a network interface. The processor 11 controls the RAM 12, the storage apparatus 14, the input apparatus 15, and the output apparatus 16 by executing the read computer program. Especially in the present example embodiment, when the processor 11 executes the read computer program, a function block for performing the authentication processing on the target and displaying the authentication result is realized in the processor 11. That is, the processor 11 may function as a controller that performs each control in the authentication system 10.

The processor 11 may be configured, for example, as a CPU (Central Processing Unit), a GPU (Graphics Processing Unit), a FPGA (field-programmable gate array), a DSP (Digital Signal Processor), an ASIC (Application Specific Integrated Circuit), or a quantum processor. The processor 11 may be configured by using one of them, or a plurality of them in parallel.

The RAM 12 temporarily stores the computer program to be executed by processor 11. The RAM 12 temporarily stores data that are temporarily used by the processor 11 when the processor 11 is executing the computer program. The RAM 12 may be, for example, a D-RAM (Dynamic Random Access Memory) or a SRAM (Static Random Access Memory). In addition, another type of volatile memory may be used in place of the RAM 12.

The ROM 13 stores the computer program to be executed by the processor 11. The ROM 13 may also store other fixed data. The ROM 13 may be, for example, a P-ROM (Programmable Read Only Memory) or an EPROM (Erasable Read Only Memory). In addition, another type of nonvolatile memory may be used in place of the ROM 13.

The storage apparatus 14 stores data that are stored by the authentication system 10 for a long time. The storage apparatus 14 may operate as a transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the authentication system 10. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example.

The output apparatus 16 is an apparatus that outputs information about the authentication system 10 to the outside. For example, the output apparatus 16 may be a display apparatus (e.g., a display) that is configured to display the information about the authentication system 10. The output apparatus 16 may be configured as a portable terminal such as a smartphone and a tablet. The output apparatus 16 may also be an apparatus that outputs information in a format other than an image. For example, the output apparatus 16 may be a speaker that audio-outputs the information about the authentication system 10.

The camera 18 is configured to capture images of the target. A plurality of cameras 18 may be disposed to capture different locations. Alternatively, a plurality of cameras 18 may be disposed to capture the same location from different angles. The camera 18 may be configured to capture a specific part of the target. For example, the camera 18 may be configured to capture the face of the target or to capture the iris of the target. Furthermore, the camera 18 may be a visible light camera or a near-infrared camera.

The display apparatus 1 is configured to perform the result display indicating the result of the authentication processing to the target. Since the display apparatus 1 may be the same as that described in the first and second example embodiments above, a detailed description thereof will be omitted.

A part of the hardware described in FIG. 1 may be provided as an external apparatus of the authentication system 10. For example, the storage apparatus 14, the input apparatus 15, the output apparatus 16, or the like, described above may be provided in an external apparatus connected to the authentication system 10. In addition, the authentication system 10 may realize a part of an arithmetic function by using an external apparatus (e.g., an external server or cloud, etc.).

### System Configuration

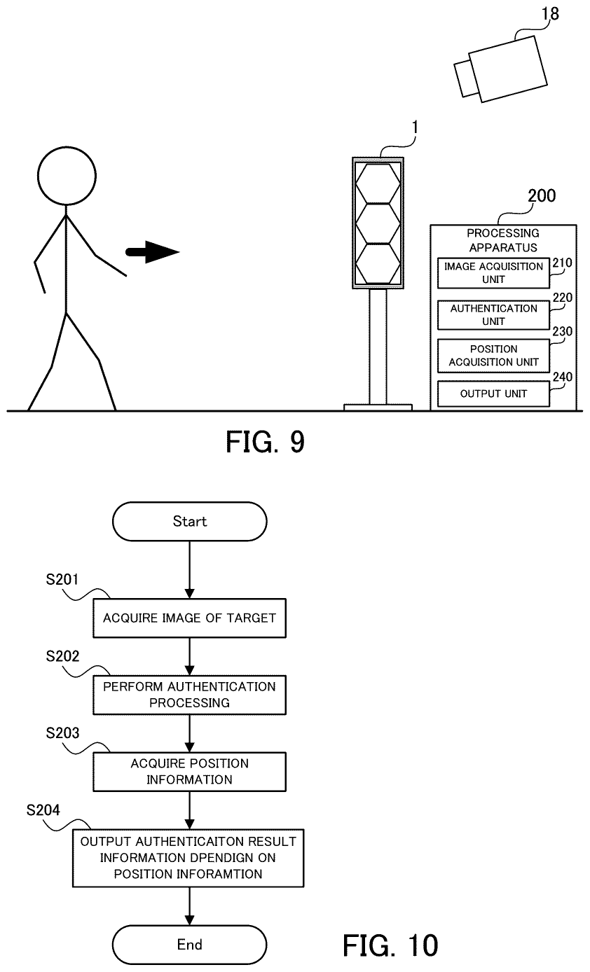

Next, with reference to FIG. 9, a configuration of the authentication system 10 according to the third example embodiment will be described. FIG. 9 is a side view illustrating the configuration of the authentication system according to the third example embodiment.

As illustrated in FIG. 9, the authentication system 10 according to the third example embodiment is configured to display the result of the authentication processing, to the target approaching the display apparatus 1. More specifically, the authentication system 10 is configured to capture the image of the target with the camera 18, perform the authentication processing on a processing apparatus 200 based on the captured image, and display the authentication result on the display apparatus 1. Such an authentication system 10 is applicable, for example, to airport boarding gates, access gates of buildings, entrance gates of theme parks, or the like.

The processing apparatus 200 is configured to transmit and receive information with the camera 18 and the display apparatus 1 and perform various types of processing in the authentication system 10. Here, for convenience of description, the processing apparatus 200 is illustrated as being disposed near the camera 18 and the display apparatus 1; however, the installation position of the processing apparatus 200 is not particularly limited. For example, the processing apparatus 200 may be disposed in a separate room distant from the camera 18 and the display apparatus 1, or even in a different facility located further away.

The processing apparatus 200 includes, as components for realizing its functions, an image acquisition unit 210, an authentication unit 220, a position acquisition unit 230, and an output unit 240. Each of the image acquisition unit 210, the authentication unit 220, the position acquisition unit 230, and the output unit 240 may be a processing block realized, for example, by the processor 11 (see FIG. 8).

The image acquisition unit 210 is configured to acquire images captured by the camera 18. Furthermore, the image acquisition unit 210 may be configured to acquire images from another camera other than the camera 18 (i.e., a not-illustrated camera) disposed near the display apparatus 1.

The authentication unit 220 is configured to perform the authentication processing using the images acquired by the image acquisition unit 210. For example, the authentication unit 220 performs facial recognition using the face of the target. The authentication unit 220 may have a function of detecting the position of the face from the image of the target. The authentication unit 220 may also have a function of extracting feature quantities from the face of the target. In that case, the authentication unit 220 may perform facial recognition using the extracted feature quantities.

The position acquisition unit 230 is configured to acquire the position of the target. The position acquisition apparatus 230 may acquire (estimate) the position of the target from the image of the target acquired by the image acquisition apparatus 210. Alternatively, the position acquisition apparatus 230 may acquire the position of the target by using other sensors or the like.

The output apparatus 240 is configured to output the authentication result information indicating the authentication result of the authentication apparatus 220, to the display apparatus 1. Furthermore, in particular, the output unit 240 according to the present example embodiment outputs the authentication result information, based on the position of the target acquired by the position acquisition unit 230. For example, the output unit 240 outputs the authentication result information in the timing that the target reaches a predetermined position.

### Flow of Operation

Next, with reference to FIG. 10, a flow of operation of the authentication system 10 according to the third example embodiment will be described. FIG. 10 is a flowchart illustrating the flow of the operation of the authentication system according to the third example embodiment.

As illustrated in FIG. 10, when the operation by the authentication system 10 according to the third example embodiment is started, first, the image acquisition unit 210 acquires the image of the target captured by the camera 18 (step S201). Then, the authentication unit 220 performs the authentication processing on the target by using the image acquired by the image acquisition unit 210 (step S202).

Then, the position acquisition unit 230 acquires the position of the target (step S203). Then, the output unit 240 outputs the authentication result of the authentication unit 220 to the display apparatus 1, based on the position of the target acquired by the position acquisition unit 230 (step S204). By this, the display apparatus 1 displays the result to the target.

Next, a technical effect obtained by the authentication system 10 according to the third example embodiment will be described.

As described in FIG. 8 to FIG. 10, in the authentication system 10 according to the third example embodiment, the authentication is performed on the target, and then, the result of the authentication processing for the target is displayed based on the position of the target. This enables the display corresponding to the position of the target, and the target may thus be appropriately notified of the authentication result

### Fourth Example Embodiment

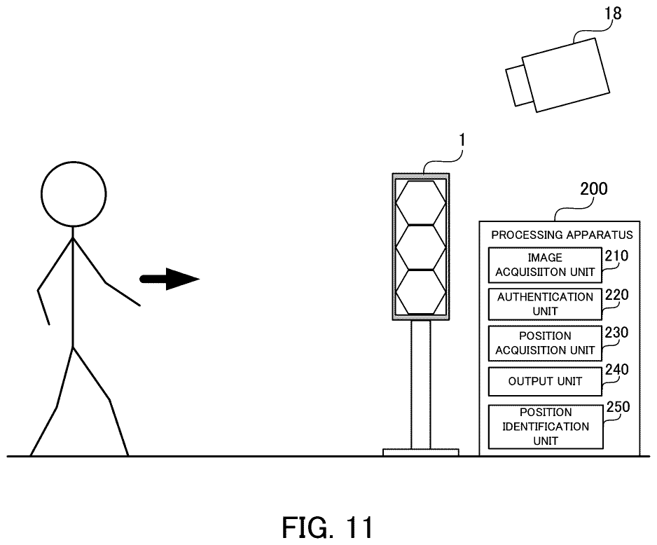

The authentication system 10 according to a fourth example embodiment will be described with reference to FIG. 11 to FIG. 14. The fourth example embodiment partially differs from the third example embodiment described above only in its configuration and operation, and may be the same as the third example embodiment in the other parts. For this reason, a part differing from each of the example embodiments described above will be described in detail below, and a description of the other overlapping parts will be omitted as appropriate.

### Authentication Method

First, an example of the authentication method adopted by the authentication system 10 according to the fourth example embodiment will be described. The authentication system 10 according to the fourth example embodiment may adopt a method of authenticating targets in a specific area (hereinafter referred to as “gateless authentication” as appropriate). The “specific area” here may be, for example, a predetermined area set in a facility or near an entrance, and may be set across a plurality of rooms or a plurality of floors.

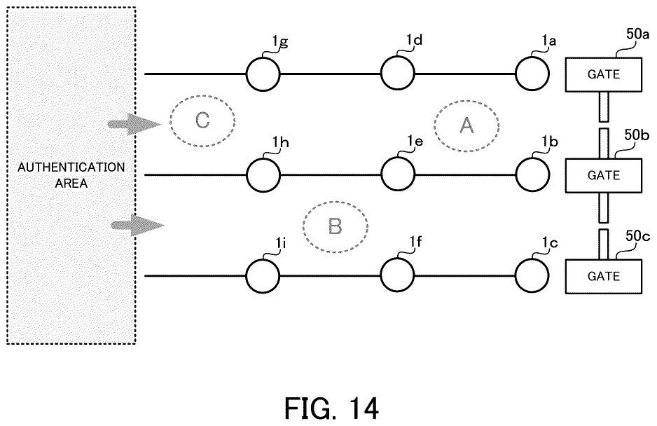

In the gateless authentication, first, the target in the specific area is detected. Then, the detected target is tracked, and the authentication is performed as appropriate. For example, in the gateless authentication, the head of the target in the specific area is detected, and tracking processing is performed on the head. Then, the facial recognition is performed by using the feature quantities in a face part included in the tracked head. In the present example embodiment, the specific area may be set as an area where a person is located before entering a gate (e.g., see FIG. 14 described later).

The facial recognition in the gateless authentication may be performed, for example, in the timing that the camera successfully captures the face of the tracked target. For example, for a target looking down at the start of tracking, the facial recognition may be performed in the timing that the target looks up. Alternatively, for a target wearing an item such as a hat, sunglasses, and a mask, at the start of tracking, the facial recognition may be performed in the timing that the target removes the item. The facial recognition process may continue for a predetermined time, a predetermined number of times, or until the target exits from the specific area.

In the authentication system 10 according to the fourth example embodiment, the result of the aforementioned gateless authentication is displayed on the display apparatus 1. However, the authentication method that is adoptable in the authentication system 10 according to the fourth example embodiment is not limited to the aforementioned gateless authentication method.

### Functional Configuration

Next, with reference to FIG. 11, a functional configuration of the authentication system 10 (more specifically, the processing apparatus 200) according to the fourth example embodiment will be described. FIG. 11 is a block diagram illustrating the configuration of the processing apparatus in the authentication system according to the fourth example embodiment. In FIG. 11, the same components as those illustrated in FIG. 9 carry the same reference numerals.

As illustrated in FIG. 11, the processing apparatus 200 of the authentication system 10 according to the fourth example embodiment includes, as components for realizing its functions, the image acquisition unit 210, the authentication unit 220, the position acquisition unit 230, the output unit 240, and a position identification unit 250. That is, the authentication system 10 according to the fourth example embodiment further includes the position identification unit 250 in addition to the configuration in the third example embodiment (see FIG. 9). The position identification unit 250 may be a processing block realized, for example, by the aforementioned processor 11 (see FIG. 1).

The position identification unit 250 is configured to identify the position of the display apparatus 1. The position identification unit 250 may identify the position of the display apparatus 1 from the image captured by the camera 18, for example. Specifically, it may identify the position of the display apparatus 1, based on at which position in the imaging area the display apparatus 1 is captured. Alternatively, the position identification unit 250 may identify the position of the display apparatus 1 from an image captured by another camera provided on the display apparatus 1 itself. Specifically, it may identify the position of the display apparatus 1, based on an object captured in the image captured in the display apparatus 1 and a position thereof. In this way, it is possible to identify the position of the display apparatus 1 with high accuracy by analyzing the captured image.

Additionally, the position identification unit 250 may identify the position of the display apparatus 1 in response to user operation. For example, the position identification apparatus 250 may display, on a screen, a map of a room where the display apparatus 1 is disposed, and may allow the user to click on a position at which the display apparatus 1 is disposed, thereby identifying the position of the display apparatus 1. Alternatively, the position identification apparatus 250 may allow the user to input the coordinates of a position at which a pole is disposed, thereby identifying the position of the display apparatus 1.

The position identification unit 250 may also have a function of storing position information on the position of the display apparatus 1 identified. This allows the stored position information on the display apparatus 1 to be read and utilized as needed. In a case where the position information is not stored, the position identification unit 250 may instead perform processing of identifying the position of the display apparatus 1 at each time.

### Calibration Operation

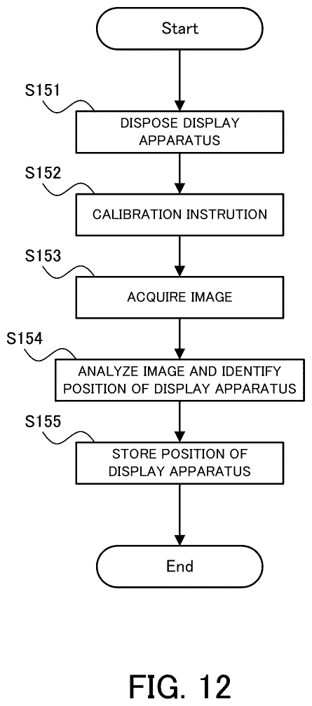

Next, with reference to FIG. 12, a flow of a calibration operation (i.e., an operation of the position identification unit 250 identifying the position of the display apparatus 1) of the authentication system 10 according to the fourth example embodiment will be described. FIG. 12 is a flowchart illustrating the flow of the calibration operation in the authentication system according to the fourth example embodiment. Hereinafter, an operation using captured images for calibration will be described as an example.

As illustrated in FIG. 12, when the calibration operation is performed, first, a facility staff member or a similar person disposes the display apparatus 1 (step S151). Then, the staff member having disposed the display apparatus 1 gives an instruction to start the calibration (step S152). For example, the staff member presses a start button on his/her own portable terminal to initiate the calibration. The installation position of the display apparatus 1 at this time may be at a position set in advance, or may be random. An effect of the calibration is that the position of the display apparatus 1 may be more accurately identified. Furthermore, even if the display apparatus 1 is randomly disposed, the position of the display apparatus 1 can still be determined. This allows the staff member to dispose each display apparatus 1 without consciously considering its installation position of the display apparatus 1, thereby improving work efficiency.

Then, the position identification unit 250 acquires an image for performing the calibration (step S153). Specifically, the position identification unit 250 acquires an image including the display apparatus 1 or an image captured in the display apparatus 1. The position identification unit 250 then analyzes the image and identifies the position of the display apparatus 1 (step S154).

The position identification unit 250 may identify the position of the display apparatus 1, for example, based on a light emission state (light emission pattern, light emission order, light emission color, light emission time, light emission intensity, etc.) of the display apparatus 1 in the acquired image. Additionally, the position identification unit 250 may acquire, in addition to or instead of the image, a video including the display apparatus 1 or a video captured in the display apparatus 1. In this case, the position identification unit 250 may analyze the acquired video, thereby identifying the light emission order, light emission time, or the like of the display apparatus 1. The light emission state may be determined in advance. In such a case, by detecting the display apparatus 1 emitting light in the predetermined state, it is possible to identify the ID and position of the display apparatus 1. For example, by determining in advance the light emission color corresponding to each ID, the ID may be identified from the light emission color. Alternatively, in a case where the light emission order of the display apparatus 1 is determined in advance, it is possible to identify the ID of the display apparatus 1 by identifying the order of light emission.

Subsequently, the position identification unit 250 stores information about the identified position, as the position information on the display apparatus 1 (step S155). The position information on the display apparatus 1 stored here will be read and used as appropriate during operation described later (i.e., operation when the display apparatus 1 is allowed to display).

### Flow of Operation

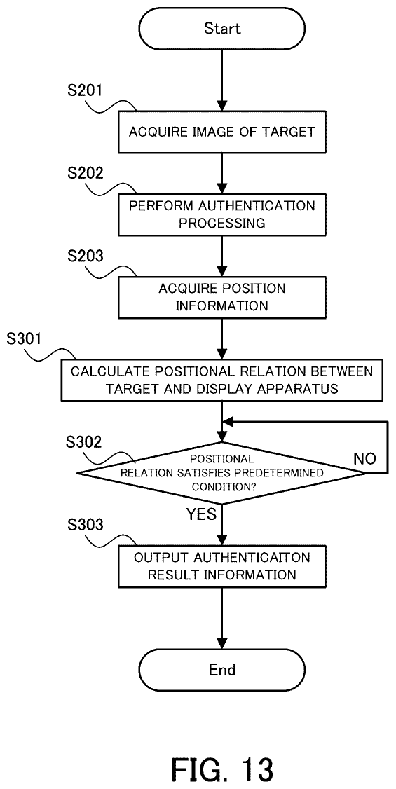

Next, with reference to FIG. 13, a flow of operation of the authentication system 10 according to the fourth example embodiment will be described. FIG. 13 is a flowchart illustrating the flow of the operation of the authentication system according to the fourth example embodiment. In FIG. 13, the same steps as those described in FIG. 10 carry the same reference numerals.

As illustrated in FIG. 13, when the operation by the authentication system 10 according to the fourth example embodiment is started, first, the image acquisition unit 210 acquires the image of the target captured by the camera 18 (step S201). Then, the authentication unit 220 performs the authentication processing on the target by using the image acquired by the image acquisition unit 210 (step S202).

Then, the position acquisition unit 230 acquires the position of the target (step S203). Especially in the present example embodiment, based on the position of the target acquired by the position acquisition unit 230 and the position of the display apparatus 1 identified by itself, the position determination unit 250 calculates a positional relation between the two. That is, the position determination unit 250 calculates a positional relation between the target and the display apparatus 1 (step S301).

Then, the output apparatus 240 determines whether or not the positional relation between the target and the display apparatus 1, which is calculated by the position determination apparatus 250, satisfies a predetermined condition (step S302). The “predetermined condition” here is a condition for determining whether or not the target can visually recognize the display by the display unit 2 of the display apparatus 1, and is set in advance through prior simulation or the like. For example, the predetermined condition may include such a condition that a distance between the target and the display apparatus 1 is less than or equal to a predetermined value.

In a case where it is determined that the positional relation between the target and the display apparatus 1 satisfies the predetermined condition (step S302: YES), the output unit 240 outputs the authentication result of the authentication unit 220 to the display apparatus 1 (step S303). On the other hand, in a case where it is determined that the positional relation between the target and the display apparatus 1 does not satisfy the predetermined condition (step S302: NO), the step S303 is not performed. That is, the output apparatus 240 does not output the authentication result of the authentication apparatus 220 to the display apparatus 1. In this case, the authentication result is outputted to the display apparatus 1 after the positional relation between the target and the display apparatus 1 satisfies the predetermined condition.

Furthermore, in a case where there are a plurality of display apparatuses 1, the output unit 240 may output the authentication result to the display apparatus 1 that satisfies the predetermined conditions out of the plurality of display apparatuses 1. The operation when the plurality of display apparatuses 1 are disposed, will be described in detail below.

### Plurality of Display Apparatuses

Next, with reference to FIG. 14, a description will be given of a control example when the plurality of display apparatuses 1 are disposed. FIG. 14 is a top view illustrating a control example of the plurality of display apparatuses in the authentication system according to the fourth example embodiment.

As illustrated in FIG. 14, a plurality of display apparatuses 1 may be disposed such that targets having passed through the authentication area in which the authentication processing by authentication unit 220 is performed (e.g., the specific area in the aforementioned “gateless authentication”) line up along gates 50 (here, 50a, 50b, 50c) to use. The gates 50 may be, for example, airport boarding gates, entrance gates at various facilities, or the like. In the example illustrated in the figure, display apparatuses 1a, 1b, and 1c are disposed near the gate 50. Behind them, display apparatuses 1d, 1e, and 1f are disposed. Further behind them, display apparatuses 1g, 1h, and 1i are disposed.

In FIG. 14, the authentication system 10 here is configured such that the predetermined condition (see S302 in FIG. 2) is satisfied on the display apparatuses 1a and 1b in a case where the target is located at a position A. Therefore, in a case where the target is located at the position A, the authentication result is outputted to the display apparatuses 1a and 1b. Consequently, the result is displayed to the target located at the position A by the display apparatuses 1a and 1b. Furthermore, the authentication system 10 is configured such that the predetermined condition is satisfied on the display apparatuses 1e and 1f in a case where the target is located at a position B. Therefore, in a case where the target is located at position B, the authentication result is outputted to the display apparatuses 1e and 1f. Consequently, the result is displayed to the target located at the position B by the display apparatuses 1e and 1f. Furthermore, the authentication system 10 is configured such that the predetermined condition is satisfied on the display apparatuses 1g and 1h in a case where the target is located at a position C. Therefore, in a case where the target is located at the position C, the authentication result is outputted to the display apparatuses 1g and 1h. Consequently, the result is displayed to the target located at the position C by the display apparatuses 1g and 1h.

By disposing the plurality of display apparatuses 1 in this manner, the display apparatus 1 may be selected based on the position of the target, to perform the display. Consequently, it is possible to notify the target of the authentication result, more appropriately. In a case where the authentication result indicates a success, processing of opening the corresponding gate 50 (i.e., processing for permitting the target to pass through the gate 50) may be performed.

As in the above example, in a case of controlling the plurality of display apparatuses 1, the processing apparatus 100 may identify in advance each of the plurality of display apparatuses before establishing a connection. In this case, for example, a unique two-dimensional code may be assigned to each display apparatus 1, and the two-dimensional code may be read, thereby establishing the connection. Alternatively, without establishing a connection, the processing apparatus 100 may simultaneously transmit information, and each display apparatus 1 may be allowed to determine whether or not the information is intended for the display apparatus 1 itself.

### Technical Effect

Next, a technical effect obtained by the authentication system 10 according to the fourth example embodiment will be described.

As described in FIG. 11 to FIG. 14, in the authentication system 10 according to the fourth example embodiment, the position of the display apparatus 1 is identified, and various types of control is performed based on the positional relation between the target and the display apparatus 1. This allows the display on the display apparatus 1 disposed at a position where the target can visually recognize it, and the target may thus be notified of the authentication result, more appropriately.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal. The program may be provided to a user in a form of Saas (Software as a Service), for example.

### SUPPLEMENTARY NOTES

The example embodiments described above may be further described as, but not limited to, the following Supplementary Notes below.

### Supplementary Note 1

A display apparatus according to Supplementary Note 1 is a display apparatus including: a display unit including a plurality of display areas located at different heights; a first control unit that controls the display unit to perform guidance display for guiding a facial orientation of a target toward an imaging unit; an authentication result acquisition unit that acquires authentication result information indicating a result of authentication processing for the target; and a second control unit that controls the display unit to perform result display corresponding to the authentication result information.

### Supplementary Note 2

A display apparatus according to Supplementary Note 2 is the display apparatus according to Supplementary Note 1, wherein the first control unit controls the display unit to gradually increase a height at which a display area to be lit up is positioned, thereby causing the display unit to perform the guidance display.

### Supplementary Note 3

A display apparatus according to Supplementary Note 3 is the display apparatus according to Supplementary Note 1 or 2, wherein the first control unit changes a display area to be lit up, depending on a height of the target.

### Supplementary Note 4

A display apparatus according to Supplementary Note 4 is the display apparatus according to any one of Supplementary Notes 1 to 3, wherein the second control unit controls the display unit to change a lighting pattern depending on the authentication result information, thereby causing the display unit to perform the result display.

### Supplementary Note 5

An authentication system according to Supplementary Note 5 is an authentication system including: an image acquisition unit that acquires an image of a target; an authentication unit that performs authentication processing by using the image of the target; a position acquisition unit that acquires a position of the target; an output unit that outputs authentication result information indicating a result of the authentication processing for the target, based on the position of the target; and a display apparatus that is disposed in an area through which the target passes and that performs result display corresponding to the authentication result information to the target.

### Supplementary Note 6

An authentication system according to Supplementary Note 6 is the authentication system according to Supplementary Note 5, further including a position identification unit that identifies a position of the display apparatus, wherein the output unit outputs the authentication result information in a case where a relation between the position of the target and the position of the display apparatus satisfies a predetermined condition.

### Supplementary Note 7

An authentication system according to Supplementary Note 7 is the authentication system according to Supplementary Note 6, wherein a plurality of display apparatuses are disposed, and the output unit outputs the authentication result information to the display apparatus that the predetermined condition is satisfied, out of the plurality of display apparatuses.

### Supplementary Note 8

An authentication system according to Supplementary Note 8 is the authentication system according to Supplementary Note 6 or 7, wherein the position identification unit identifies the position of the display apparatus, based on an image captured to include the display apparatus or an image captured in the display apparatus.

### Supplementary Note 9

An authentication method according to Supplementary Note 9 is an authentication method that is executed by at least one computer, the authentication method including: acquiring an image of a target; performing authentication processing by using the image of the target; acquiring a position of the target; outputting authentication result information indicating a result of the authentication processing for the target, based on the position of the target; and using a display apparatus that is disposed in an area through which the target passes, thereby performing result display corresponding to the authentication result information to the target.

### Supplementary Note 10

A recording medium according to Supplementary Note 10 is a recording medium on which a computer program that allows at least one computer to execute an authentication method is recorded, the authentication method including: acquiring an image of a target; performing authentication processing by using the image of the target; acquiring a position of the target; outputting authentication result information indicating a result of the authentication processing for the target, based on the position of the target; and using a display apparatus that is disposed in an area through which the target passes, thereby performing result display corresponding to the authentication result information to the target.

### Supplementary Note 11

A computer program according to Supplementary Note 11 is a computer program that allows at least one computer to execute an authentication method, the authentication method including: acquiring an image of a target; performing authentication processing by using the image of the target; acquiring a position of the target; outputting authentication result information indicating a result of the authentication processing for the target, based on the position of the target; and using a display apparatus that is disposed in an area through which the target passes, thereby performing result display corresponding to the authentication result information to the target.

The present disclosure is allowed to be changed, if desired, without departing from the essence or spirit of this disclosure which can be read from the claims and the entire specification. A display apparatus, an authentication system, an authentication method, and a recording medium with such changes are also intended to be within the technical scope of the present disclosure.

### DESCRIPTION OF REFERENCE CODES

Display apparatus
2 Display unit
3 Battery
4 Control unit
5 Pole
6 Flat plate
10 Authentication system
11 Processor
18 Camera
110 Guidance control unit
120 Authentication result acquisition unit
130 Result display control unit
200 Processing apparatus
210 Image acquisition unit
220 Authentication unit
230 Position acquisition unit
240 Output unit
250 Position identification unit

What is claimed is:

1. A display apparatus comprising:
a display unit including a plurality of display areas located at different heights;
at least one memory that is configured to store instructions; and
at least one processor that is configured to execute the instructions to:
control the display unit to perform guidance display for guiding a facial orientation of a target toward an imaging unit;
acquire authentication result information indicating a result of authentication processing for the target; and
control the display unit to perform result display corresponding to the authentication result information.

2. The display apparatus according to claim 1, wherein the at least one processor is configured to execute the instructions to control the display unit to gradually increase a height at which a display area to be lit up is positioned, thereby causing the display unit to perform the guidance display.

3. The display apparatus according to claim 1, wherein the at least one processor is configured to execute the instructions to change a display area to be lit up, depending on a height of the target.

4. The display apparatus according to claim 1, wherein the at least one processor is configured to execute the instructions to control the display unit to change a lighting pattern depending on the authentication result information, thereby causing the display unit to perform the result display.

5. An authentication system comprising:
at least one memory that is configured to store instructions; and
at least one processor that is configured to execute the instructions to:
acquire an image of a target;
perform authentication processing by using the image of the target;
acquire a position of the target;
output authentication result information indicating a result of the authentication processing for the target, based on the position of the target; and
use a display apparatus that is disposed in an area through which the target passes, thereby performing result display corresponding to the authentication result information to the target.

6. The authentication system according to claim 5, wherein the at least one processor is configured to execute the instructions to:
identifies-identify a position of the display apparatus; and
output the authentication result information in a case where a relation between the position of the target and the position of the display apparatus satisfies a predetermined condition.

7. The authentication system according to claim 6, wherein
a plurality of display apparatuses are disposed, and
the at least one processor is configured to execute the instructions to output the authentication result information to the display apparatus that the predetermined condition is satisfied, out of the plurality of display apparatuses.

8. The authentication system according to claim 6, wherein the at least one processor is configured to execute the instructions to identify the position of the display apparatus, based on an image captured to include the display apparatus or an image captured in the display apparatus.

9. An authentication method that is executed by at least one computer, the authentication method comprising:
acquiring an image of a target;
performing authentication processing by using the image of the target;
acquiring a position of the target;
outputting authentication result information indicating a result of the authentication processing for the target, based on the position of the target; and
using a display apparatus that is disposed in an area through which the target passes, thereby performing result display corresponding to the authentication result information to the target.

10. (canceled)
